(19) United States
(12) Patent Application Publication
(10) Pub. No.: US 2026/0151734 A1
(43) Pub. Date: Jun. 4, 2026

(54) HYDROGEN SULFIDE REMOVAL PROCESS

(71) Applicant: Merichem Company, Houston, TX (US)

(72) Inventor: David Jackson, Fort Bend, TX (US)

(73) Assignee: Merichem Technologies, LLC, Houston, TX (US)

(21) Appl. No.: 19/123,347

(22) PCT Filed: Dec. 7, 2023
(86) PCT No.: PCT/US2023/082840

§ 371 Date: Apr. 22, 2025

Related U.S. Application Data
(60) Provisional application No. 63/431,415, filed on Dec. 9, 2022.

(51) Int. Cl. B01D 53/96; B01D 53/14; B01D 53/86; C01B 17/05

(52) U.S. Cl. CPC B01D 53/96; B01D 53/1412; B01D 53/1425; B01D 53/1468; B01D 53/8612; B01D 53/8696; C01B 17/05; B01D 2251/90; B01D 2255/20738; B01D 2256/24; B01D 2257/304

(57) ABSTRACT

A method and apparatus for removal of hydrogen sulfide from a process gas stream is presented where the process gas is contacted in an absorber with a liquid catalyst to remove the hydrogen sulfide and produce a sweetened process gas stream. The liquid catalyst with absorbed hydrogen sulfide as an admixture is sent directly to a separate stand-alone oxidation unit without subjecting the admixture of spent liquid catalyst to a separation process that removes dissolved gas. The admixture is directed directly into a downcomer in tire oxidation unit positioned between a combined oxidation and. flash stage and a deaeration stage, where hydrocarbon gases carried over from the process gas stream are separated and removed from the oxidation unit. Removing a final admixture from the oxidation unit and recirculating a first portion of the final admixture to the absorber and second portion to a sulfur removal unit that is physically located at elevation above the oxidation unit.

### CROSS-REFERENCE TO RELATED APPLICATIONS

This application is a national stage application, filed under 35 U.S.C. 371, of International Patent Application No. PCT/US2023/082840, filed Dec. 7, 2023, which claims priority to provisional U.S. Application No. 63/431,415 filed Dec. 9, 2022, the contents of which are hereby incorporated by reference in its entirety.

### TECHNICAL FIELD

The present disclosure is directed to a method and combination of unit operations for selectively removing hydrogen sulfide (H₂S) gas from a hydrocarbon containing process gas stream using a polyvalent metal redox catalyst solution, such as an iron chelate absorption to react the H₂S gas selectively from the process gas stream to form elemental sulfur. M ore particularly, the present invention is an improvement over known processes in that the footprint of the overall process is significantly reduced by removing the known degassing or flash drum unit operations that follows downstream of the absorber vessel. To further reduce the footprint, the elemental sulfur removal unit operation is positioned and elevated above the reaction/oxidization unit operation to allow for gravity feed of recovered filtrate, thus eliminating expensive pumping equipment and storage vessels.

### BACKGROUND

Processes for removal of H₂S from process gas streams are known. For example, U.S. Pat. No. 5,126,118 uses an absorber, degasser, reactor/oxidizer chamber and a sulfur filtration process for removing H₂S from a process gas. The process gas is contacted with a liquid catalytic metal redox absorption solution. Such a process is illustrated in FIG. 1. Sour process gas (feed gas 5) containing H₂S is introduced into an absorber vessel 2 where the H₂S is absorbed by a polyvalent metal redox solution introduced through line 10 producing a sweet (treated) process gas stream 12 that is removed from the absorber 2. A spent liquid catalyst solution with the absorbed H₂S is removed from the absorber via line 14. The hydrocarbons in the sour gas feed will reach equilibrium with the liquid catalytic metal redox absorption solution. These soluble hydrocarbons must be removed before reaching the oxidation section of the reactor/oxidizer unit operation 18 in order to avoid the potential for fire or explosion. Removal of the dissolved hydrocarbon gases is accomplished using a degassing unit operation that includes a flash drum 16 and associated piping, flow control, valving and other apparatus to allow the spent catalyst solution removed from the absorber via line 14 to be degassed.

The absorbed H₂S and degassed spent catalyst solution is removed from the flash drum 16 via line 17 and introduced into oxidizer 18. This is schematically illustrated in FIG. 2. Substantially completely oxidized polyvalent metal redox solution from a final stage 18a of an oxidizer chamber via a deaeration section 18b is recirculated to the absorber via a regenerated solution pump. This reaction to elemental sulfur occurs during oxidation of the reduced polyvalent metal redox solution in the oxidation stages 18a of the oxidation chamber 18. The formed elemental sulfur is removed from the process using a combination of unit operations 20 that includes a solids filter, filtration vessel, filtrate pump, filter drip pan, bag filters and vessel, wash water line, control valves, wash water pump and associated piping.

Several disadvantages are known regarding prior processes used to remove H₂S from process gas feeds. One such disadvantage is the spatial footprint occupied by overall process, especially the footprints relating to the degassing unit operation and the separate sulfur recovery unit operation. Another disadvantage is capital costs associated with the equipment used in these unit operations, as well as the operating utility costs to operate the needed pumps and control valves. Yet another problem associated with the use of a separate degassing unit operation is the increased residence time experienced by the absorbed H₂S and spent catalyst solution once removed from the absorber and then introduced into the degassing unit operation. This increased residence time can lead to a higher potential for sulfur settling and plugging due to delayed regeneration. Delayed regeneration can also lead to the formation of undesirable over spent/reduced catalyst which may result in permanent loss of polyvalent metal in the form of a solid sulfide.

The below described improved hydrogen sulfide removal process reduces residence time before reaction to elemental sulfur, allows for the use of gravity fed process streams, reduces the spatial footprint occupied by the improved process, as well as eliminating a number of equipment and utility costs.

### SUMMARY

The process and apparatus of the present disclosure are adaptable to any H₂S removal process that uses a polyvalent metal redox solution in two valence states for absorption of H₂S, with or without other impurities, and regeneration of the metal redox solution.

The series of reactions involved in catalytically oxidizing sulfur contaminants, such as hydrogen sulfide, to elemental sulfur using an iron chelate catalyst can be represented by the following reactions, where L generically represents the two or more particular ligands chosen to formulate the metal chelate catalyst admixture:

$$H2S ( gas ) + H2O ( liq . ) ∘ H2S ( aqueous ) + H2O ( liq . ) \qquad ( 1 )$$

$$H2S ( aqueous ) ∘ {H}^{+} + HS - \qquad ( 2 )$$

$$HS - + 2 ( {Fe}^{3 +} L2 ) ∘ S ( solid ) + 2 ( {Fe}^{2 +} L2 ) + {H}^{+} \qquad ( 3 )$$

By combining equations (1) through (3) the resulting equation is:

$$H 2 S ( gas ) + 2 ( {Fe}^{3 +} L 2 ) ∘ 2 {H}^{+} + 2 ( {Fe}^{2 +} L 2 ) + S ( solid ) \qquad ( 4 )$$

In order to have an economical workable process for removing hydrogen sulfide from a gaseous stream when a polyvalent metal chelate admixture is used to effect catalytic oxidation of the hydrogen sulfide, it is essential that the ferrous iron chelate formed, as exemplified above, be continuously regenerated by oxidizing to ferric iron chelate on contacting the reaction solution with dissolved oxygen, preferably in the form of ambient air, in the same or in a separate contact zone. The series of reactions which take place in the oxidizer stages of the presently disclosed oxidation unit operation when regenerating the metal chelate catalyst can be represented by the following equations:

$$O 2 ( gas ) + 2 H 2 O ∘ O 2 ( aqueous ) + 2 H 2 O \qquad ( 5 )$$

$${O}_{2 ( aqueous )} + 2 {H}_{2} O + 4 ( {Fe}^{2 +} {L}_{2} ) ∘ 4 ( OH — ) + 4 ( {Fe}^{3 +} {L}_{2} ) \qquad ( 6 )$$

By combining equations (5) through (6), the resulting equation (7) is:

$$1 / 2 O 2 + H2O + 2 ( {Fe}^{2 +} L 2 ) ∘ 2 ( OH — ) + 2 ( {Fe}^{3 +} L 2 ) \qquad ( 7 )$$

And, when equations (4) and (7) are combined, the overall process can be represented by the following equation:

$$H 2 S ( gas ) + 1 / 2 O 2 ( gas ) ∘ S ( solid ) + H 2 O ( liq . ) \qquad ( 8 )$$

directed to a method and apparatus for removing H₂S from a process gas using a catalytic metal redox absorption solution, for absorption of H₂S in an absorber chamber and conveying the spent polyvalent metal redox solution directly into an oxidation and flash stage without flowing into a separate degassing unit operation. Degassing of the absorbed hydrocarbons from the sour process gas stream being treated occurs in the oxidation and flash stage of the reactor/oxidization unit operation before the spent liquid catalyst enters a series of separate oxidizer stages.

The process of the present disclosure can be characterized as an anaerobic process scheme because the sour feed gas containing H₂S, which is substantially free of oxygen, is treated in an anaerobic absorber vessel and the resultant admixture of spent liquid catalyst, absorbed H₂S, and any dissolved hydrocarbon is not contacted with air or other oxygen-containing gas stream until after being processed in a separate oxidation unit operation. Importantly, the present process does not use a separate degassing unit operation and, as such, does not use a flash drum, control valves or associated piping. Instead, the admixture from the absorber directly enters a oxidation unit operation that uses a separate vessel having multiple chambers or stages. The admixture is directed first into a combined oxidation and flash stage where no oxygen containing gas is introduced or in some alternative embodiments only a very small amount of air can be introduced to assist in flow and/or liquid level control. The amount of air volume introduced should be controlled to ensure the resulting gas mixture remains above the Upper Flammability Limit. Alternatively, a larger volume of air can be introduced to ensure the resulting gas mixture remains below the Lower Flammability Limit. In no circumstance is the amount of oxygen in the oxidation and flash stage allowed to reach a flammability or combustion level. A flammable gas monitoring instrument may be deployed to monitor the gas vent and adjust the air rate to maintain the desired concentration. Alternatively, the air rate may be controlled on a ratio based on the liquid and/or gas flowrates entering the absorber vessel.

Any dissolved hydrocarbon gases in the admixture are removed in the combined oxidation and flash stage and are removed from the oxidation vessel for further processing or mixing with the sweetened hydrocarbon gasses removed from the absorber. The absorbed H₂S entering the combined oxidation and flash stage are converted to elemental sulfur by contact with freshly regenerated liquid catalyst solution flowing cocurrent within the oxidation vessel and into the combined oxidation and flash stage from the last oxidation stage in oxidation vessel after first passing through a deaeration stage where any excess oxygen containing gas is removed. The freshly regenerated catalyst solution comprising highly oxidized polyvalent metal redox solution mixes with and contacts the admixture (i.e., the H₂S-laden spent redox solution) taken from the absorber vessel to reoxidize the dissolved HS— and S⁼ and any of the polyvalent metal sulfur compounds (presumably a chelated iron sulfide). Circulation of solution from the last oxygenation stage and through the deaeration stage, preferably through a valve or other circulation control device, to the combined oxidation and flash stage provides controlled and continuous supply of oxidized metal to react with sulfide resulting in the formation of elemental sulfur in the combined oxidation and flash stage. This permits high rates of solution circulation through the oxidation vessel without high pumping costs usually associated with circulation of theoretical quantities of polyvalent metal solution at low concentration through the absorber.

Upon exiting the reaction chamber the spent catalyst solution is then contacted with air or other oxygen-containing gas stream in a series of multiple oxidation stages that can employ spargers or other dispersion devices to introduce the oxygen-containing gas into the series of one or more oxidizer stages. Contact of the reduced polyvalent metal redox solution, i.e., the spent liquid catalyst, with the oxygen containing gas re-oxidizes the polyvalent metal redox solution to create a highly oxidized polyvalent metal redox solution, i.e., a regenerated liquid catalyst, that is removed from the oxidation vessel and then recirculated back to the absorber vessel for contact with the incoming sour gas feed stream.

A portion of the regenerated liquid catalyst is removed from the recirculated stream being sent to the absorber. That removed portion is continuously sent to a sulfur removal unit operation. However, unlike known sulfur removal unit operations, such as illustrated in FIG. 1, the process of the present disclosure requires that the sulfur unit operation be physically located above the oxidation vessel or at a minimum elevated to a vertical height above the oxidation vessel. In other words, the sulfur removal unit operation must be at a higher elevation than the oxidation vessel, preferably directly above the oxidation vessel so that the sulfur removal unit operation shares the same footprint as the oxidation vessel. Most preferably, the sulfur unit operation will not have a footprint that is separate than that of the oxidation vessel, thus overall process footprint can be greatly reduced.

Requiring the sulfur removal unit operation to be at a higher elevation than the oxidation vessel allows for gravity feeding of filtrate and/or collected liquid captured in a filter drip pan directly into the oxidation vessel using one or more diptubes. Using gravity to introduce liquid streams directly into the oxidation vessel eliminates the need for pumps, piping, level controllers, holding vessels and control valves, thus saving on capital and energy costs. Preferably, the one or more diptubes are inserted directly into a low pressure section of the oxidation vessel below the liquid surface. This prevents gasses from the sulfur removal unit operation from escaping the process. The use of a drip pan provides for a secondary containment of leaks or errant sprays resulting from washing the filtered sulfur in the sulfur removal operation. In a typical sulfur removal process the drip pan would drain into a secondary filtration process. In the process of the present disclosure, because the entire sulfur removal unit operation is elevated above the oxidation vessel a gravity diptube can be used thus avoiding the need and cost of a secondary filtration system, which also reduces the footprint of the process.

In summary, the process and apparatus of the present disclosure allows for continuously removing hydrogen sulfide (H₂S) gas from a sour process gas stream by intimate contact with a catalytic polyvalent metal redox solution in an absorption mass transfer zone (i.e., an adsorber vessel) to form a reduced polyvalent metal redox solution containing dissolved HS— and S⁼ ions. The liquid removed from the absorber vessel is directly introduced into a separate oxidation unit without first introducing the reduced polyvalent metal redox solution in a separate deassing unit operation. Instead, the reduced polyvalent metal redox is directly introduced into a separate combined oxidation and flash stage of the oxidation unit where the dissolved HS— and S⁼ ions are converted to elemental sulfur and any dissolved hydrocarbons are separated and vented from the oxidation unit. This reduces the residence time that the absorbed HS— and S⁼ is contained in the spent liquid catalyst solution before oxidation occurs. Liquid residence time can be reduced by as much as 50% by eliminating the known degassing unit operation. The degassed polyvalent metal redox solution in the combined oxidation and flash stage is then directly contacted in a series of multiple oxidation stages to regenerate the liquid catalyst by re-oxidizing the polyvalent metal redox solution. The formed elemental sulfur is removed in a sulfur removal unit operation that is physically positioned above the oxidation unit so as to reduce the process footprint and to take advantage of one or more gravity fed diptubes feeding the oxidation unit, thus eliminating the need for pumps, level controls, holding vessels and associated piping.

### BRIEF DESCRIPTION OF THE DRAWINGS

The above and other aspects and advantages of the present invention will become more apparent from the following detailed description of the preferred embodiments taken in conjunction with the drawings wherein:

FIG. 1 is a process flow diagram of a known H₂S removal process;

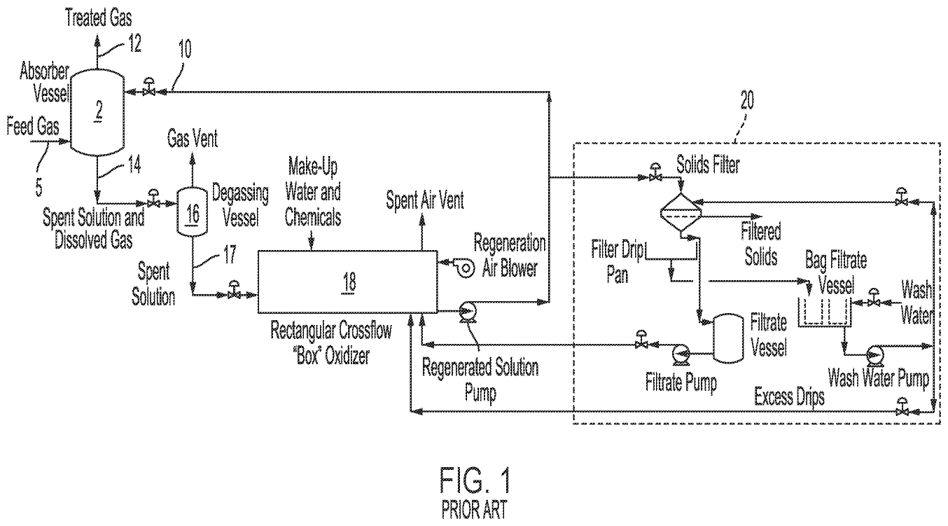

FIG. 2 is a schematic flow of the oxidation unit from FIG. 1;

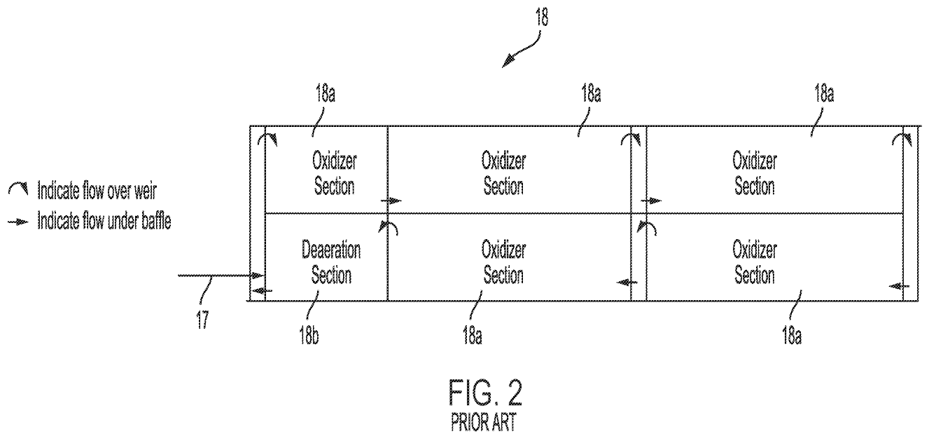

FIG. 3 is a process flow diagram of one embodiment of the H₂S removal process of the present disclosure, where the sulfur removal unit operation is position at an elevated position directly above the oxidation unit operation;

FIG. 4 is a schematic flow of the oxidation unit from FIG. 3;

FIG. 5 is a schematic top view of the oxidation unit operation from FIG. 3;

FIG. 6A is a flowchart of a first portion of a process; and

FIG. 6B is a flowchart of a second portion of the process of FIG. 6A.

### DETAILED DESCRIPTION

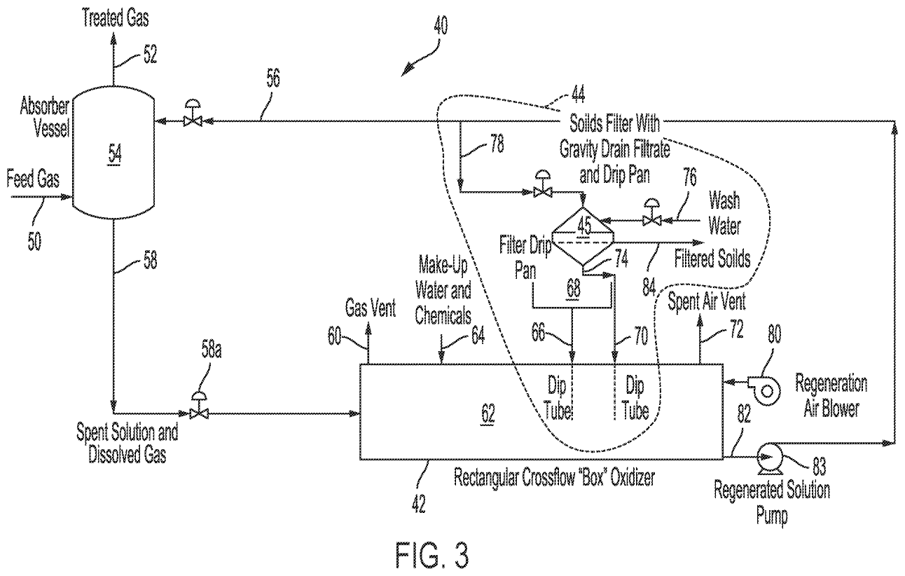

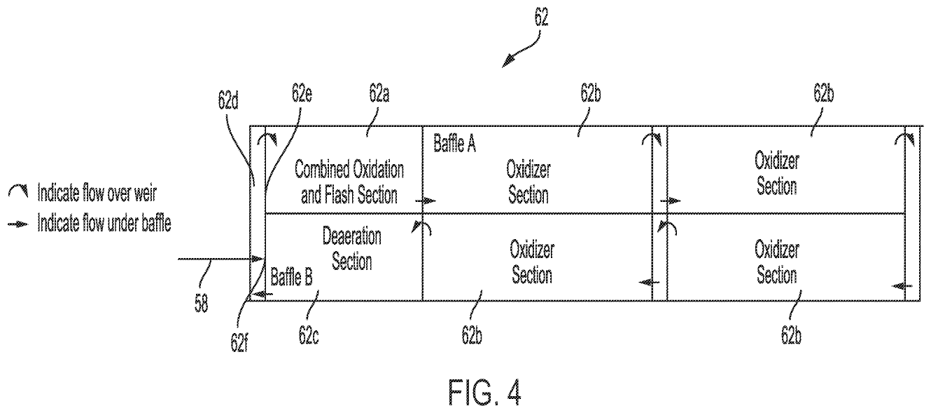

Turning now to the drawings, and initially to FIG. 3, there is shown one possible embodiment of a process flow diagram for an H₂S removal process of the present disclosure, generally designated by reference numeral 40. The process includes a separate absorber vessel 54, a oxidation unit operation 42 and a sulfur removal unit operation 44. The oxidation unit 42 is generally shown schematically in FIG. 4 to include a combined oxidation and flash stage 62a and a series of oxidation stages 62b, where a plurality of down comers 62d, weirs 62e and baffles 62f are present that direct and control the flow of liquid within the oxidation unit 62. Four oxidizer stages 62b are illustrated in FIG. 4 for the absorption of oxygen from air or other oxygen-containing gas stream introduced through blower 80. The combined oxidation and flash stage 62a is preceded by a first downcomer where the spent polyvalent metal solution with the absorbed H₂S from the absorber vessel 54 can be introduced prior to entering the combined oxidation and flash stage 62a via flow over the weir 62e. Alternatively, all or a portion of the spent polyvalent metal solution with the absorbed H₂S from the absorber vessel 54 can be added directly to the combined oxidation and flash stage 62a. Highly oxidized polyvalent metal redox solution, i.e., regenerated liquid catalyst flows into the first down corner under the baffle 62f after first passing through a deaeration stage 62c where entrained air or oxygen is removed from the regenerated solution providing a gas free liquid phase for pump suction. And in this improved design preventing oxygen carryover into the oxidation and flash stage 62a. The regenerated liquid catalyst flowing into the deaeration stage from the last oxidizer stage is essentially free of HS— or S⁼.

An H₂S-containing process gas, e.g., a sour gas, flows through line 50 into absorber 54 and fresh polyvalent metal redox solution (combined regenerated and/or make-up new liquid catalyst) is pumped from deaeration stage 62c via line 82 and pump 83 (FIG. 3). The highly oxidized liquid catalyst in stream is introduced into the absorber 54 through input line 56, where a submerged conduit or other gas dispersion device, e.g., a sparger, ensures intimate contact with the liquid catalyst introduced through line 56 and taken from oxidation unit 62. The H₂S-laden polyvalent metal redox solution, i.e., spent liquid catalyst, from the absorber 54 flows by gravity or by pressure differences through conduit 58 into the downcomer directly adjacent to the combined oxidation and flash stage 62a. Importantly, there is no liquid/gas separator unit operation between the absorber 54 and oxidation unit 62, thus the residence time of between the absorber and the oxidation unit 62 is kept to a minimum, preferably less than 5 minutes.

The dissolved and absorbed hydrogen sulfide components removed by adsorption from the process gas that are contained in the spent polyvalent metal redox solution removed from the absorber 54 and directly introduced into the oxidation unit 62 is reacted with highly oxidized polyvalent metal redox solution from the deaeration stage 62c after flowing through downcomer 62d. The dissolved and absorbed hydrogen sulfide components are converted to elemental sulfur, or soluble polysulfides incapable of oxidation to thiosulfate or sulfate, in the combined oxidation and flash stage, and importantly dissolved hydrocarbon gas not previous removed from the absorber 54 is removed and vented through line 60. This conversion starts even in the absorber as the catalyst begins to reduce in the presence of hydrogen sulfide. Little to no oxygen is present in the combined oxidation and flash stage so that the risk of fire and/or explosion is minimized. Preferably, the amount of oxygen in the combined oxidation and flash stage is kept low enough that the flammable gas is always above is Upper Flammability Limit.

After the sulfur and polyvalent metal redox solution has been degassed in the combined oxidation and flash stage, the solution flows under a baffle 62f and into the first oxidizer stage 62b where the polyvalent metal redox solution is oxidized by the oxygen containing gas (preferably air) flowing through on or more spargers located in each oxidizer stage. The partially oxidized polyvalent metal redox solution flows over weirs 62e and under baffles 62f and into each of oxidizer stages 62b. In each successive oxidizer stage the partially oxidized solution is further oxidized by the oxygen containing gas injected into each stage. From the last oxidizer stage (shown as the fourth stage in FIG. 4) the fully and highly oxidized polyvalent metal redox solution flows over a weir 62e and into a deaeration stage where excess gasses are removed prior to contacting the incoming spent liquid catalyst in down corner 62d. Make-up or fresh liquid catalyst can be added via line 64 to any of the oxidizer stages 62b.

As indicated in FIG. 3 elemental sulfur is removed from the process as filtered solids via line 84 using a sulfur removal unit operation 44. Importantly, the sulfur removal unit operation must be elevated above the oxidation unit 62 so as to utilize one or more gravity fed diptubes 66 or 70. A slip stream 78 continuously feeds the sulfur removal unit operation 44 and is taken from the regenerated liquid catalyst stream 82 that is recirculated to the absorber 54. This slip stream is forced through a solids filtering device 45, where line 76 introduces water to wash sulfur solids collected by a filter apparatus. The washed and recovered sulfur solids are removed from the process through line 84. A filtrate stream 74 containing regenerated liquid catalyst is gravity fed through a diptube 70 directly into one or more of the oxidizer stages 62b. Because the sulfur removal unit operation 44 is positioned spatially at a vertical elevation above the oxidation unit 62, gravity is used as the driving force to introduce the filtrate into the oxidizer stage without requiring a holding tank, a pump, or other associated piping and level controllers needed in previously known processes. The use of a gravity fed diptube also allows the filtrate to be selectively introduced below the surface of the liquid in the oxidizer stage. The filtrate can be added using a diptube to any of the stages, 62b is one preferred approach. However, since the filtrate flow is intermittent and generally a much lower flow than the internal circulation, so there is no detriment to adding it anywhere in the vessel 42. The diptube also prevents any flash gas or air from flowing backwards from the vessel into the area around the filter. Further the diptubes prevent odors or potentially flammable gas from migrating to unwanted areas around the filter.

Another benefit of requiring the sulfur removal unit operation 44 to be elevated directly above the oxidation unit 62 is that a filter drip pan 68 that is located below the solids filtering process 45 can also use a gravity fed diptube 66. The filter drip pan 68 is designed to collect leaks of filtrate that can occur from the filtering process and the diptube 66 can direct any collected leaked filtrate directly into one or more oxidizer stages 62b, again without the need of a holding tank, a pump, or other associated piping and level controllers needed in previously known processes.

Gas dispersion devices, such as spargers, can be used in the one or more oxidizer stages 62b. Such dispersion devices can be formed simply from pieces of slit and plugged hose attached to a pipe disposed along the bottom of one or more of the oxidizer stages. Similarly, other configurations of air spargers or diffusers can be used, as is well known to those skilled in the art. Excess oxygen containing gas is removed from the oxidation unit 62 via vent line 72, which also vents the deaeration stage 62c because stages 62b and 62c have a common gas space along the top of the oxidation unit 62.

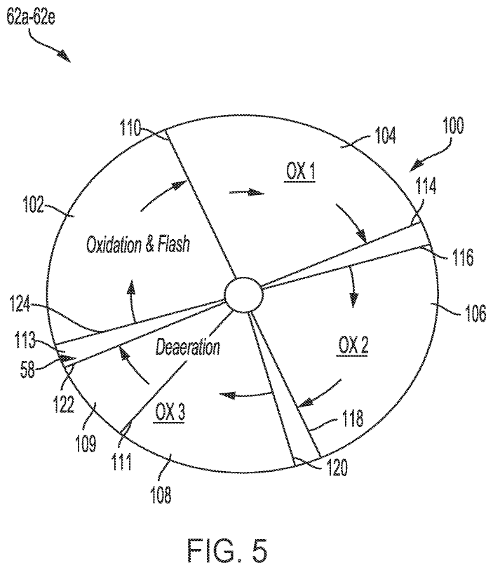

A circular design for the oxidation unit 62 can be used to further reduce the overall footprint of the of the process and apparatus. One such design is shown in FIG. 5, is generally designated 100, and includes a combined oxidation and flash chamber 102 and a series of oxidizer chambers, 104, 106 and 108. A deaeration stage 109 is located between the last oxidizer stage 108 and downcomer 113 where the spent liquid catalyst and absorbed H₂S are introduced via line 58. Horizontally and vertically spaced weir and baffle combination 122 and 124 define the downcomer 62d that separates the deaeration chamber 109 from the combined oxidation and flash chamber 102. Other weir and baffle combinations, 114/116 & 118/120, define other downcomers and separate oxidizer chambers 106 and 108. A single baffle 110 disposed between the combined oxidation and flash chamber 102 and the first oxidation stage 104 so that liquid flows under the baffle 110 to reach the first oxidizer stage 104. Similarly, a single weir 111 is disposed between the deaeration chamber 10 and the last oxidation stage 108 so that liquid flows over the weir 111 to reach the downcomer 113. The baffles where the liquid flows under prevents fluid communication above the liquid level between adjacent stages. Although not shown in FIG. 5, air spargers can be disposed in oxidizer stages 104, 106 and 108.

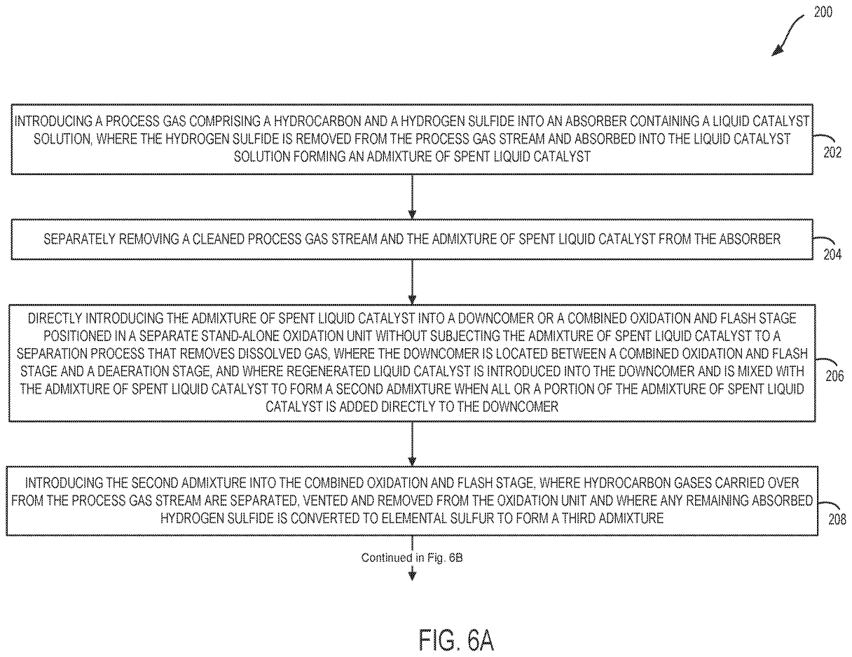

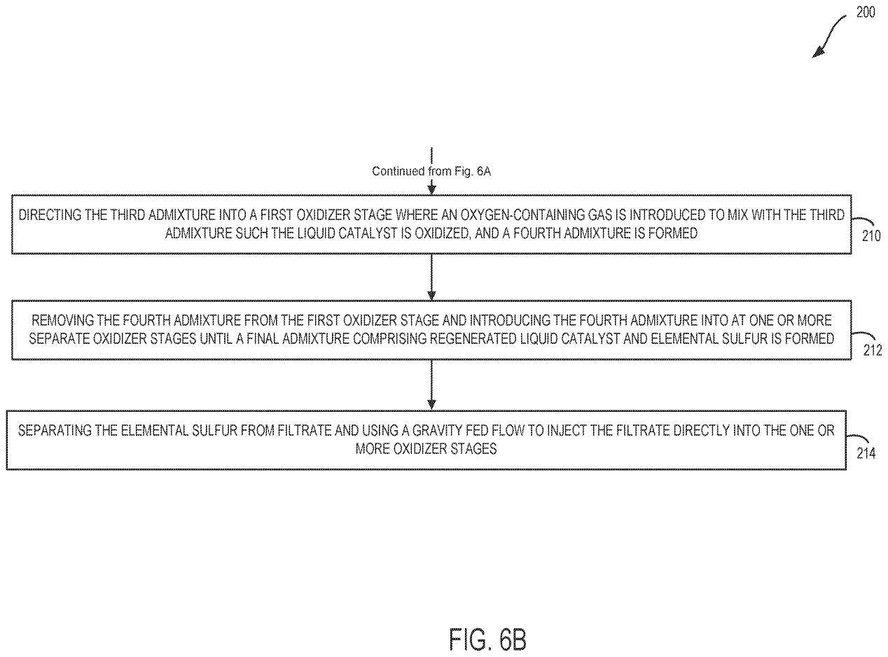

FIGS. 6A-6B illustrate a block diagram of an example a continuous process for contacting a liquid reagent sequentially with a process gas and a second gas. Process 200 shown in FIGS. 6A-6B presents an embodiment of a method that could be used by the devices described above in relation to FIGS. 3-5, as examples. Method 200 may include one or more operations, functions, or actions as illustrated by one or more of blocks 202-214. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

Initially, at block 202, the process 200 includes introducing a process gas comprising a hydrocarbon and a hydrogen sulfide into an absorber containing a liquid catalyst solution, where the hydrogen sulfide is removed from the process gas stream and absorbed into the liquid catalyst solution forming an admixture of spent liquid catalyst.

At block 204, the process 200 also includes separately removing a cleaned process gas stream and the admixture of spent liquid catalyst from the absorber.

At block 206, the process 200 also includes directly introducing the admixture of spent liquid catalyst into a downcomer or a combined oxidation and flash stage positioned in a separate stand-alone oxidation unit without subjecting the admixture of spent liquid catalyst to a separation process that removes dissolved gas, where the downcomer is located between a combined oxidation and flash stage and a deaeration stage, and where regenerated liquid catalyst is introduced into the downcomer and is mixed with the admixture of spent liquid catalyst to form a second admixture when all or a portion of the admixture of spent liquid catalyst is added directly to the downcomer.

At block 208, the process 200 also includes introducing the second admixture into the combined oxidation and flash stage, where hydrocarbon gases carried over from the process gas stream are separated, vented and removed from the oxidation unit and where the absorbed hydrogen sulfide is converted to elemental sulfur to form a third admixture.

At block 210, the process 200 also includes directing the third admixture into a first oxidizer stage where an oxygen-containing gas is introduced to mix with the third admixture such the liquid catalyst is oxidized, and a fourth admixture is formed.

At block 212, the process 200 also includes removing the fourth admixture from the first oxidizer stage and introducing the fourth admixture into at one or more separate oxidizer stages until a final admixture comprising regenerated liquid catalyst and elemental sulfur is formed.

At block 214, the process 200 also includes separating the elemental sulfur from filtrate and using a gravity fed dip tube to inject the filtrate directly into the one or more oxidizer stages.

In one example, the process further includes removing the final admixture from the oxidation unit and recirculating a first portion of the final admixture to the absorber and a second portion to a sulfur removal unit that is physically located at elevation above the oxidation unit and a third portion that is recirculated inside the oxidation unit. A third portion of this flow is recirculated through the oxidizer via the downcomer. Liquid traffic is in a circle through the chambers and various flows may be added/removed from it.

In one example, the first portion of the final admixture recirculated to the absorber is less than 75% by weight of the final admixture. In another example, flow of liquid through the oxidation unit is achieved by solution density differences in successive stages of the oxidation unit. In another example, the liquid catalyst is a polyvalent metal redox solution, and the oxygen-containing gas is air.

In another example, the filtrate comprises a portion of the liquid catalyst and the elemental sulfur is recovered from a water wash and filtering apparatus that produces the filtrate. In such an example, the process may further include a drip pan located at an elevation below the water wash and filtering apparatus that receives liquid leaking from the sulfur removal unit, where the received leaked liquid is gravity fed to the one or more oxidizer stages through a dip tube.

In another example, a concentration and a flow rate of liquid catalyst in the absorber provides more than 100% of a stoichiometric quantity of polyvalent metal redox solution required for reaction with all of the hydrogen sulfide in the process gas stream. In another example, wherein the liquid catalyst is a catalytic ferric iron chelate solution that is reduced by hydrogen sulfide gas to a ferrous iron solution in the absorber. In another example, the deaeration stage removes free gaseous oxygen from the regenerated liquid catalyst. In another example, the combined oxidation and flash stage removes free gaseous hydrocarbons from the second admixture, and wherein the removed free gaseous hydrocarbons are removed from the oxidation unit through a vent directly connected to the combined oxidation and flash stage.

In another example, the one or more oxidizer stages are separated by additional downcomers defined by a weir and baffle configuration, where the one or more oxidizer stages are in open liquid communication, one with another. In another example, the process further include an oxygen containing gas vent that removes excess oxygen containing gas from one of the one or more oxidizer stages. In another example, the process further includes a make-up liquid catalyst line directly connected to the combined oxidation and flash stage for introducing make-up liquid catalyst, water or other chemicals into the combined oxidation and flash stage. In another example, the process further includes a control valve located between the absorber and the separate stand-alone oxidation unit that is configured to reduce a pressure of the admixture of spent liquid catalyst before entering the separate stand-alone oxidation unit and to cause any dissolved hydrocarbons to be converted to free gaseous hydrocarbons.

The foregoing description of the specific embodiments will so fully reveal the general nature of the invention that others can, by applying current knowledge, readily modify and/or adapt for various application such specific embodiments without departing from the generic concept, and therefore such adaptations and modifications are intended to be comprehended within the meaning and range of equivalents of the disclosed embodiments. It is to be understood that the phraseology or terminology herein is for the purpose of description and not of limitation. Moreover, the present disclosure has been made only by way of preferred embodiments and that numerous changes in details or construction, combination and arrangement of parts and process steps can be resorted to without departing from the spirit and scope of the invention as hereunder claimed.

What is claimed is:

1. A continuous process for contacting a liquid reagent sequentially with a process gas and a second gas, the process comprising:
(a) introducing a process gas comprising a hydrocarbon and a hydrogen sulfide into an absorber containing a liquid catalyst solution, where the hydrogen sulfide is removed from the process gas stream and absorbed into the liquid catalyst solution forming an admixture of spent liquid catalyst;
(b) separately removing a cleaned process gas stream and the admixture of spent liquid catalyst from the absorber;
(c) directly introducing the admixture of spent liquid catalyst into a downcomer or a combined oxidation and flash stage positioned in a separate stand-alone oxidation unit without subjecting the admixture of spent liquid catalyst to a separation process that removes dissolved gas, where the downcomer is located between a combined oxidation and flash stage and a deaeration stage, and where regenerated liquid catalyst is introduced into the downcomer and is mixed with the admixture of spent liquid catalyst to form a second admixture when all or a portion of the admixture of spent liquid catalyst is added directly to the downcomer;
(d) introducing the second admixture into the combined oxidation and flash stage, where hydrocarbon gases carried over from the process gas stream are separated, vented and removed from the oxidation unit and where any remaining absorbed hydrogen sulfide is converted to elemental sulfur to form a third admixture;
(d) directing the third admixture into a first oxidizer stage where an oxygen-containing gas is introduced to mix with the third admixture such the liquid catalyst is oxidized, and a fourth admixture is formed;
(e) removing the fourth admixture from the first oxidizer stage and introducing the fourth admixture into at one or more separate oxidizer stages until a final admixture comprising regenerated liquid catalyst and elemental sulfur is formed; and
(f) separating the elemental sulfur from filtrate and using a gravity fed flow to inject the filtrate directly into the one or more oxidizer stages.

2. The process of claim 1, further comprising:
removing the final admixture from the oxidation unit and recirculating a first portion of the final admixture to the absorber and second portion to a sulfur removal unit that is physically located at elevation above the oxidation unit and a third portion that is recirculated inside the oxidation unit.

3. The process of claim 2, wherein the first portion of the final admixture recirculated to the absorber is less than 75% by weight of the final admixture.

4. The process of claim 2, wherein the filtrate comprises a portion of the liquid catalyst and the elemental sulfur is recovered from a water wash and filtering apparatus that produces the filtrate.

5. The process of claim 4, further comprising a drip pan located at an elevation below the water wash and filtering apparatus that receives liquid leaking from the sulfur removal unit, where the received leaked liquid is gravity fed to the one or more oxidizer stages through a dip tube.

6. The process of claim 1, wherein flow of liquid through the oxidation unit is achieved by solution density differences in successive stages of the oxidation unit vs the associated downcomer.

7. The process of claim 1, wherein the liquid catalyst is a polyvalent metal redox solution, and the oxygen-containing gas is air.

8. The process of claim 1, wherein a concentration and a flow rate of liquid catalyst in the absorber provides more than 100% of a stoichiometric quantity of polyvalent metal redox solution required for reaction with all of the hydrogen sulfide in the process gas stream.

9. The process of claim 1, wherein the liquid catalyst is a catalytic ferric iron chelate solution that is reduced by hydrogen sulfide gas to a ferrous iron solution in the absorber.

10. The process of claim 1, where the deaeration stage removes free gaseous oxygen from the regenerated liquid catalyst.

11. The process of claim 1, wherein the combined oxidation and flash stage removes free gaseous hydrocarbons from the second admixture, and wherein the removed free gaseous hydrocarbons are removed from the oxidation unit through a vent directly connected to the combined oxidation and flash stage.

12. The process of claim 1, wherein the one or more oxidizer stages are separated by additional downcomers defined by a weir and baffle configuration, where the one or more oxidizer stages are in open liquid communication, one with another.

13. The process of claim 1, further comprising an oxygen containing gas vent removes excess oxygen containing gas from one of the one or more oxidizer stages.

14. The process of claim 1, further comprising a make-up liquid catalyst line directly connected to the combined oxidation and flash stage for introducing make-up liquid catalyst, water or other chemicals into the combined oxidation and flash stage.

15. The process of claim 1, further comprising a control valve located between the absorber and the separate stand-alone oxidation unit that is configured to reduce a pressure of the admixture of spent liquid catalyst before entering the separate stand-alone oxidation unit and to cause any dissolved hydrocarbons to be converted to free gaseous hydrocarbons.
